(19) United States
(12) Patent Application Publication
(10) Pub. No.: US 2021/0242504 A1
(43) Pub. Date: Aug. 5, 2021

(54) MANUFACTURING METHOD FOR ALL-SOLID-STATE LITHIUM SECONDARY BATTERY

(71) Applicant: TDL CO., LTD., Gwangju (KR)

(72) Inventors: Yu Sin Kim, Gwangju (KR); Jung Huan Kim, Gwangju (KR)

(73) Assignee: TDL CO., LTD., Gwangju (KR)

(21) Appl. No.: 17/048,989

(22) PCT Filed: Apr. 24, 2018
(86) PCT No.: PCT/KR2018/004714

§ 371 Date: Oct. 19, 2020

(30) Foreign Application Priority Data
Apr. 20, 2018 (KR) 10-2018-0046027

(51) Int. Cl. H01M 10/0585; H01M 4/04; H01M 4/62; H01M 10/0525

(52) U.S. Cl. CPC H01M 10/0585; H01M 4/0409; H01M 4/0407; H01M 10/0525; H01M 4/0471; H01M 4/043; H01M 4/624

(57) ABSTRACT

Disclosed is a manufacturing method for an all-solid-state lithium secondary battery.

### TECHNICAL FIELD

The present invention relates to a manufacturing method of an all-solid-state lithium secondary battery.

### BACKGROUND ART

Since a lithium secondary battery has high output and excellent charge and discharge performance, the use of the lithium secondary battery has expanded from mobile devices such as mobile phones and the like to automobiles, energy storage, and the like. Accordingly, safety enhancement and high performance of the lithium secondary battery are demanded.

An all-solid-state lithium secondary battery is a battery in which a liquid electrolyte which is present in a liquid state among a positive electrode, an electrolyte, and a negative electrode constituting a lithium secondary battery is replaced with a solid electrolyte, and can reduce risks of ignition, explosion, and the like of the liquid electrolyte of a conventional lithium secondary battery, and thus is attracting attention as a next-generation battery.

A conventional all-solid-state lithium secondary battery was manufactured by slurrying a positive electrode material, a solid electrolyte material, and a negative electrode material, to respectively coat and cure the positive electrode material, the solid electrolyte material, and the negative electrode material on individual base films, and then laminating each layer after removing the base films. In this case, there is a problem in that the performance of the all-solid-state lithium secondary battery is degraded due to the interface resistance between a positive electrode layer, a solid electrolyte layer, and a negative electrode layer.

### DISCLOSURE

### Technical Problem

The present invention is to solve several problems including the above-described problems, and is directed to providing a manufacturing method of an all-solid-state lithium secondary battery which is simple, enables mass production, and can reduce the interface resistance between a positive electrode layer and a solid electrolyte layer, and the interface resistance between the solid electrolyte layer and a negative electrode layer. However, these subjects are exemplary, and the scope of the present invention is not limited thereby.

### Technical Solution

One aspect of the present invention provides a manufacturing method of an all-solid-state lithium secondary battery, including: coating a first electrode slurry on a base film proceeding in a roll-to-roll manner, performing a first heat treatment, and performing first pressurization to form a first electrode layer; coating a solid electrolyte slurry on the first electrode layer, performing a second heat treatment, and performing second pressurization to form a solid electrolyte layer; and coating a second electrode slurry on the solid electrolyte layer, performing a third heat treatment, and performing third pressurization to form a second electrode layer.

The first electrode may be a positive electrode, and the second electrode may be a negative electrode.

The first electrode may be a negative electrode, and the second electrode may be a positive electrode.

At least one of the first electrode slurry, the solid electrolyte slurry, and the second electrode slurry may include a conductive polymer.

The first heat treatment may be performed at a temperature of 20° C. to 40° C.

The second heat treatment may be performed at a temperature of 20° C. to 40° C.

The third heat treatment may be performed at a temperature of 20° C. to 40° C.

The manufacturing method may further include a fourth heat treatment operation after the first heat treatment and before the first pressurization.

The fourth heat treatment operation may be performed at a temperature of 60° C. to 70° C.

The manufacturing method may further include a fifth heat treatment operation after the second heat treatment and before the second pressurization.

The fifth heat treatment operation is performed at a temperature of 60° C. to 70° C.

The manufacturing method may further include a sixth heat treatment operation after the third heat treatment and before the third pressurization.

The sixth heat treatment operation is performed at a temperature of 60° C. to 70° C.

At least one of the first pressurization, the second pressurization, and the third pressurization may be performed by thermocompression.

The thermocompression may be performed at a temperature of 60° C. to 70° C. and a pressure of 0.5 MPa to 0.7 MPa.

### Advantageous Effects

A manufacturing method of an all-solid-state lithium secondary battery according to one embodiment of the present invention is simple, and in an all-solid-state lithium secondary battery manufactured by the manufacturing method, there is an effect in that the interface resistance between a positive electrode layer, a solid electrolyte layer, and a negative electrode layer is reduced and thus high output characteristics are exhibited.

Further, the all-solid-state lithium secondary battery manufactured by the manufacturing method of an all-solid-state lithium secondary battery according to one embodiment of the present invention is a sheet-type secondary battery, and thus can be cut in various forms, and accordingly, various types of secondary batteries can be manufactured.

### DESCRIPTION OF DRAWINGS

FIG. 1 is a flow chart illustrating a manufacturing method of an all-solid-state lithium secondary battery according to one embodiment of the present invention.

FIG. 2 is a view schematically illustrating an all-solid-state lithium secondary battery manufacturing apparatus to which the manufacturing method of an all-solid-state lithium secondary battery according to one embodiment of the present invention is applied.

### MODES OF THE INVENTION

Since the present invention may be variously changed and have various embodiments, particular embodiments are exemplified in the drawings and described in detail in the detailed description. However, the present invention is not limited to the particular embodiments and includes all changes, equivalents, and substitutes within the spirit and the scope of the present invention.

Further, although the terms “first,” “second,” and the like may be used herein to describe various elements, the elements should not be limited by the terms. The terms may be used only to distinguish one element from another.

In the specification, a case in which a part such as a layer or the like is “on” or “above” another part includes not only a case in which the part is “directly on” another part but also a case in which still another part is present between the part and another part.

According to one aspect, a manufacturing method of an all-solid-state lithium secondary battery includes: coating a first electrode slurry on a base film proceeding in a roll-to-roll manner, performing a first heat treatment, and performing first pressurization to form a first electrode layer; coating a solid electrolyte slurry on the first electrode layer, performing a second heat treatment, and performing second pressurization to form a solid electrolyte layer; and coating a second electrode slurry on the solid electrolyte layer, performing a third heat treatment, and performing third pressurization to form a second electrode layer, wherein the first electrode is a positive electrode and the second electrode is a negative electrode, or the first electrode is a negative electrode and the second electrode is a positive electrode.

Hereinafter, for convenience of description, the first electrode is assumed to be a positive electrode, and the second electrode assumed to be a negative electrode.

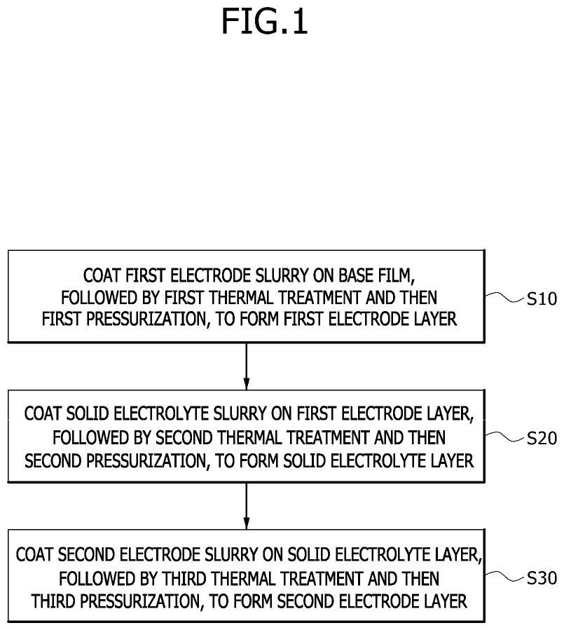

FIG. 1 is a flow chart illustrating a manufacturing method of an all-solid-state lithium secondary battery according to one embodiment of the present invention. Referring to FIG. 1, a first electrode slurry is coated on a base film proceeding in a roll-to-roll manner, a first heat treatment is performed, and then first pressurization is performed to form a first electrode layer (S10).

The base film is not particularly limited as long as it can be generally used in the art. For example, a material of the base film may be polyethylene terephthalate (PET), polyethylene naphthalate (PEN), oriented polypropylene (OPP), polyimide (PI), or a combination thereof, and the base film may have a thickness of 50 μm to 100 μm. When the thickness of the base film is smaller than 50 separation of the base film and the first electrode layer is difficult, and there is a risk in that the base film may be torn during separation, and when the thickness of the base film is greater than 100 there is a problem in that manufacturing costs of the all-solid-state lithium secondary battery increase.

The first electrode slurry may be, for example, a positive electrode slurry. The positive electrode slurry may be prepared by a method generally used in the art, and for example, the positive electrode slurry may be prepared by mixing a positive electrode active material precursor, and then selectively mixing a conductive material, a solvent, a binder, a conductive polymer, and the like. A positive electrode active material is not particularly limited as long as it is a material used as a positive electrode active material of a lithium secondary battery, and for example, the positive electrode active material may be represented by a following Chemical Formula 1.

LiaM¹_{1-b}M²_{b}A₂ [Chemical Formula 1]

(In Chemical Formula 1, M¹ is Ni, Co, Mn, V, or a combination thereof, M² is Al, Ni, Co, Mn, Cr, Fe, Mg, Sr, V, rare-earth elements, or a combination thereof, A is O, F, S, P, or a combination thereof, and a is 0 to 2.4 and b is 0 to 0.5). According to one embodiment, the positive electrode active material may be LiCoO₂, LiNi_{1/3}Co_{1/3}Mn_{1/3}O₂, LiNi_{0.8}Co_{0.1}Mn_{0.1}O₂, LiNi_{0.7}Co_{0.15}Mn_{0.15}O₂, LiMn₂O₄, LiNi_{0.8}Co_{0.15}Al_{0.05}O₂, or a combination thereof.

The first electrode slurry may selectively include a conductive material. The conductive material is not particularly limited as long as it can be generally used in the art, and may be, for example, artificial graphite, natural graphite, carbon black, acetylene black, Ketjen black, Denka black, thermal black, channel black, carbon fiber, metal fiber, aluminum, tin, bismuth, silicon, antimony, nickel, copper, titanium, vanadium, chromium, manganese, iron, cobalt, zinc, molybdenum, tungsten, silver, gold, lanthanum, ruthenium, platinum, iridium, titanium oxide, polyaniline, polythiophene, polyacetylene, polypyrrole, or a combination thereof.

The first electrode slurry may selectively include a solvent. The solvent is not particularly limited as long as it can be generally used in the art, and may be, for example, an organic solvent such as N-methyl pyrrolidone (NMP), dimethyl formamide (DMF), acetone, dimethyl acetamide, or the like, or water. These solvents may be used alone or in combination.

The first electrode slurry may selectively include a binder. The binder is not particularly limited as long as it can be generally used in the art, and may be, for example, one or more selected from a non-aqueous binder such as a vinylidene fluoride-hexafluoropropylene copolymer (PVDF-co-HEP), polyvinylidene fluoride (PVDF), polyacrylonitrile, polymethylmethacrylate, polyvinyl alcohol, carboxymethyl cellulose (CMC), starch, hydroxypropyl cellulose, regenerated cellulose, polyvinylpyrrolidone, tetrafluoroethylene, polyethylene, polypropylene, polyacrylic acid, an ethylene-propylene-diene monomer (EPDM), sulfonated EPDM, poly tetrafluoroethylene (PTFE), polyvinylidene fluoride (PVdF) or the like, an aqueous binder such as acrylonitrile-butadiene rubber, styrene-butadiene rubber (SBR), acrylic rubber, or the like, and a polymeric resin such as hydroxyethyl cellulose, carboxymethyl cellulose, polyvinylidene fluoride, or the like.

The first electrode slurry may selectively include a conductive polymer. The conductive polymer is not particularly limited as long as it can be generally used in the art. The conductive polymer generally refers to a polymer which expresses a conductivity of 1×10⁻⁴ Scm⁻¹ or more, and in most cases, high conductivity may be obtained by doping an electron acceptor or an electron donor into the polymer. As the conductive polymers, for example, doped polyethylene, polypyrrole, polythiophene, and the like are representatively known. According to one embodiment, the conductive polymer may be polyethylene oxide, polyethylene glycol, polypropylene oxide, polyphosphazene, polysiloxane, a mixture or polymer thereof, but is not limited thereto. When the first electrode slurry includes the conductive polymer, ionic conductivity and adhesion between the first electrode layer and the solid electrolyte layer may be further enhanced.

The method of coating the first electrode slurry on the base film is not particularly limited as long as it can be generally used in the art, and for example, spin coating, dip coating, spray coating, Dr. blade coating, roll coating, bar coating, gravure coating, slot-die coating, and the like may be used.

The first heat treatment may be performed at a temperature of, for example, 20° C. to 40° C., at a rate of, for example, 3 M/min, but is not limited thereto. Volatile substances which may be present in the first electrode slurry are pyrolyzed by the first heat treatment, and accordingly, a first electrode layer material is stabilized.

After the first heat treatment, a fourth heat treatment may be selectively further performed. According to one embodiment, a temperature of the fourth heat treatment may be greater than the temperature of the first heat treatment. For example, the fourth heat treatment may be performed at a temperature of 60° C. to 70° C., at a rate of, for example, 3 M/min. Volatile substances which are not pyrolyzed during the first heat treatment may be additionally pyrolyzed by the fourth heat treatment, and accordingly, the first electrode layer material may be more stabilized. Further, when the first electrode slurry includes the conductive polymer, there is an effect in that the first electrode materials become denser due to thermal expansion of the conductive polymer.

The first pressurization may be performed at a pressure of, for example, 0.5 MPa to 0.7 MPa, but is not limited thereto. According to one embodiment, the first pressurization may be performed using a thermocompression means, and in this case, the pressure may be 0.5 MPa to 0.7 MPa, the temperature may be 60° C. to 70° C., and the rate may be 3 M/min. A more uniform and thinner first electrode layer may be formed by the first pressurization.

A thickness of the first electrode layer prepared in operation S10 may be 50 μm to 200 μm, but is not limited thereto. It is possible to form an all-solid secondary battery having excellent capacity, output, energy density, cycle life, and the like within the thickness range.

Subsequently, a solid electrolyte slurry is coated on the first electrode layer prepared in operation S10, a second heat treatment is performed, and then a solid electrolyte layer is formed through second pressurization (S20).

The solid electrolyte slurry may be prepared by a method generally used in the art, and for example, the solid electrolyte slurry may be prepared by mixing a solid electrolyte precursor, and then selectively mixing a conductive material, a solvent, a binder, a conductive polymer, and the like. The solid electrolyte is not particularly limited as long as it is a material generally used in an all-solid-state lithium secondary battery. For example, the solid electrolyte may be a lithium phosphorus oxynitride (LiPON) system, a garnet system, a perovskite system, a Na-super ionic conductor (NASICON) system, or the like. According to one embodiment, the solid electrolyte may be represented by the following Chemical Formula 2 or 3.

LiₓLa_{y}Zr_{z}O₁₂ [Chemical Formula 2]

(in Chemical Formula 2, x is 6 to 9, y is 2 to 4, and z is 1 to 3)

LiₓLa_{y}Zr_{z}M_{w}O₁₂ [Chemical Formula 3]

(In Chemical Formula 3, M is Al, Na, K, Rb, Cs, Fr, Mg, Ca, Ta, B, Nb, Sb, Sn, Hf, Bi, W, Se, Ga, Ge or a combination thereof, and x is 5 to 9, y is 2 to 4, z is 1 to 3, and w is greater than 0 and less than or equal to 1). For example, the solid electrolyte may be Li₇La₃Zr₂O₁₂, but is not limited thereto. For descriptions of the conductive material, the solvent, the binder, and the conductive polymer, refer to the above.

The solid electrolyte slurry may selectively include a conductive polymer. In this case, ionic conductivity and adhesion between the first electrode layer and the solid electrolyte layer and between the solid electrolyte layer and the second electrode layer may be further enhanced.

For a method of coating the solid electrolyte slurry on the first electrode layer, refer to the above-described method of coating the first electrode slurry on the base film.

The second heat treatment may be performed at a temperature of, for example, 20° C. to 40° C., at a rate of, for example, 3 M/min, but is not limited thereto. Volatile substances which may be present in the solid electrolyte slurry are pyrolyzed by the second heat treatment, and accordingly, a solid electrolyte layer material is stabilized.

After the second heat treatment, a fifth heat treatment may be selectively further performed. According to one embodiment, a temperature of the fifth heat treatment may be greater than the temperature of the second heat treatment. For example, the fifth heat treatment may be performed at a temperature of 60° C. to 70° C., at a rate of, for example, 3 M/min. Volatile substances which are not pyrolyzed during the second heat treatment may be additionally pyrolyzed by the fifth heat treatment, and accordingly, the solid electrolyte layer material may be more stabilized. Further, when the solid electrolyte slurry includes the conductive polymer, there is an effect in that the solid electrolyte layer materials become denser due to thermal expansion of the conductive polymer.

The second pressurization may be performed at a pressure of, for example, 0.5 MPa to 0.7 MPa, but is not limited thereto. According to one embodiment, the second pressurization may be performed using a thermocompression means, and in this case, the pressure may be 0.5 MPa to 0.7 MPa, the temperature may be 60° C. to 70° C., and the rate may be 3 M/min. The first electrode layer and the solid electrolyte layer may be brought into closer contact with each other and a more uniform and thinner first electrode layer may be formed by the second pressurization.

A thickness of the solid electrolyte layer prepared in operation S20 may be 50 μm to 100 μm, but is not limited thereto. It is possible to form an all-solid secondary battery having excellent ion conductivity and rate characteristics within the thickness range.

Subsequently, a second electrode slurry is coated on the solid electrolyte layer prepared in operation S20, a third heat treatment is performed, and then the second electrode layer is formed through third pressurization (S30).

The second electrode slurry may be prepared by a method generally used in the art, and for example, the second electrode slurry may be prepared by selectively mixing a conductive material, a solvent, a binder, a conductive polymer, and the like with a negative electrode active material. The negative electrode active material is not particularly limited as long as it is a material generally used as a negative electrode active material of a lithium secondary battery. For example, the negative electrode active material may be a lithium metal; a lithium alloy such as a LiAl-based alloy, a LiAg-based alloy, a LiPb-based alloy, or a LiSi-based alloy alloyed with lithium; metal oxides such as TiO₂, SnO₂, and the like; or a carbon material such as graphite, carbon fiber, soft carbon, hard carbon, and the like. For descriptions of the conductive material, the solvent, the binder, and the conductive polymer, refer to the above.

The second electrode slurry may include a conductive polymer, and in this case, the ionic conductivity and adhesion between the solid electrolyte layer and the second electrode layer may be enhanced.

For a method of coating the second electrode slurry on the solid electrolyte layer, refer to the above-described method of coating the first electrode slurry on the base film.

The third heat treatment may be performed at a temperature of, for example, 20° C. to 40° C., at a rate of, for example, 3 M/min, but is not limited thereto. Volatile substances which may be present in the second electrode slurry are pyrolyzed by the third heat treatment, and accordingly, a second electrode layer material is stabilized.

After the third heat treatment, a sixth heat treatment may be selectively further performed. According to one embodiment, a temperature of the sixth heat treatment may be greater than the temperature of the third heat treatment. For example, the sixth heat treatment may be performed at a temperature of 60° C. to 70° C., at a rate of, for example, 3 M/min. Volatile substances which are not pyrolyzed during the third heat treatment may be additionally pyrolyzed by the sixth heat treatment, and accordingly, the second electrode layer material may be more stabilized. Further, when the second electrode slurry includes the conductive polymer, there is an effect in that the second electrode layer materials become denser due to thermal expansion of the conductive polymer.

The third pressurization may be performed at a pressure of, for example, 0.5 MPa to 0.7 MPa, but is not limited thereto. According to one embodiment, the third pressurization may be performed using a thermocompression means, and in this case, the pressure may be 0.5 MPa to 0.7 MPa, the temperature may be 60° C. to 70° C., and the rate may be 3 M/min. The solid electrolyte layer and the second electrode layer may be brought into closer contact with each other and a more uniform and thinner second electrode layer may be formed by the third pressurization.

A thickness of the second electrode layer prepared in operation S30 may be 50 μm to 200 μm, but is not limited thereto. It is possible to form an all-solid secondary battery having excellent capacity, output, energy density, cycle life, and the like within the thickness range.

In the manufacturing method of an all-solid-state lithium secondary battery according to one embodiment of the present invention, the first electrode layer, the solid electrolyte layer, and the second electrode layer are not individually prepared and then laminated, but the solid electrolyte layer is directly formed by coating the solid electrolyte slurry on the first electrode layer, and the second electrode layer is directly formed by coating the second electrode slurry on the solid electrolyte layer. Accordingly, the manufacturing method may be simple, the interface resistance between each layer may be minimized, and the all-solid-state lithium secondary battery manufactured by the manufacturing method of an all-solid-state lithium secondary battery according to one embodiment of the present invention may exhibit more excellent output characteristics.

Further, the all-solid-state lithium secondary battery manufactured by the manufacturing method of an all-solid-state lithium secondary battery according to one embodiment of the present invention has a thin sheet shape and thus may be cut into a desired shape.

According to one embodiment, after removing the base film, an operation of attaching a first current collector onto the first electrode layer from which the base film has been removed may be further included. A method of attaching the first current collector may include pressurizing the first current collector after locating the first current collector on the first electrode layer, and the pressurization may be performed by, for example, thermocompression. The first current collector may be formed of, for example, a metal such as nickel (Ni), copper (Cu), steel use stainless (SUS), titanium (Ti), chromium (Cr), manganese (Mn), iron (Fe), cobalt (Co), zinc (Zn), molybdenum (Mo), tungsten (W), silver (Ag), gold (Au), aluminum (Al), or the like, and may have a foil shape or a mesh shape, but is not limited thereto. According to one embodiment, the first current collector may be an SUS foil or an aluminum foil, but is not limited thereto.

According to one embodiment, an operation of attaching a second current collector onto the second electrode layer may be further included. A method of attaching the second current collector may include pressurizing the second current collector after locating the second current collector on the second electrode layer, the pressurization may be performed by, for example, thermocompression. For a material and shape of the second current collector, refer to the above-described material and shape of the first current collector.

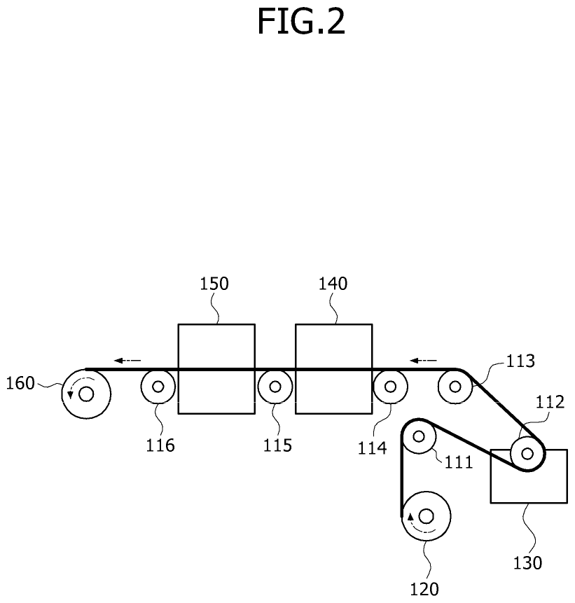

FIG. 2 is a view schematically illustrating an all-solid-state lithium secondary battery manufacturing apparatus to which the manufacturing method of an all-solid-state lithium secondary battery according to one embodiment of the present invention is applied. Referring to FIG. 2, the base film wound on a supply roll 120 is transferred by transferring rolls 111, 112, 113, 114, 115, and 116 while being unwound. First, the base film passes through a slurry accommodating part 130 which accommodates the first electrode slurry, and in this case, the first electrode slurry is coated on the base film. In FIG. 2, a dip coating method is shown as an example, but a coating method of the present invention is not limited thereto. The first electrode slurry coated on the base film undergoes the first heat treatment (or the first heat treatment and the fourth heat treatment) while passing through a heating part 140, and then the first electrode slurry undergoes the first pressurization while passing through the pressurizing part 150 to form the first electrode layer. The first electrode layer on the base film may be wound on a winding roll 160, and the wound first electrode layer on the base film may be wound around the supply roll 120 again. After changing the slurry in the slurry accommodating part 130 from the first electrode slurry to the solid electrolyte slurry, the first electrode layer on the base film passes through the slurry accommodating part 130, and in this case, the solid electrolyte slurry is coated on the first electrode layer. The solid electrolyte slurry coated on the first electrode layer undergoes the second heat treatment (or the second heat treatment and the fifth heat treatment) while passing through the heating part 140, and then the solid electrolyte slurry undergoes the second pressurization while passing through the pressurizing part 150 to form the solid electrolyte layer. The solid electrolyte layer on the first electrode layer on the base film may be wound by the winding roll 160, and the wound solid electrolyte layer may be wound around the supply roll 120 again. After changing the slurry in the slurry accommodating part 130 from the solid electrolyte slurry to the second electrode slurry, the solid electrolyte layer on the first electrode layer on the base film passes through the slurry accommodating part 130, and in this case, the second electrode slurry is coated on the solid electrolyte layer. The second electrode slurry coated on the solid electrolyte layer undergoes the third heat treatment (or the third heat treatment and the sixth heat treatment) while passing through the heating part 140, and then the second electrode slurry undergoes the third pressurization while passing through the pressurizing part 150 to form the second electrode layer. The second electrode layer on the solid electrolyte layer on the first electrode layer on the base film may be wound by the winding roll 160. Selectively, the first electrode layer on the base film and/or the solid electrolyte layer on the first electrode layer on the base film may not be wound around the winding roll 160 and may be directly transferred to the slurry accommodating part. As described above, when the first electrode slurry, the solid electrolyte slurry, and the second electrode slurry are sequentially coated on the base film while changing the type of slurry in the slurry accommodating part 130, there is an advantage of reducing costs of manufacturing equipment.

An example shown in FIG. 2 is an example of a manufacturing apparatus to which the manufacturing method of an all-solid-state lithium secondary battery according to one embodiment of the present invention is applied, and various other manufacturing apparatuses may be exemplified in addition to this. For example, a manufacturing apparatus in which a first slurry accommodating part including a first electrode slurry, a first heating part, a first pressurizing part, a second slurry accommodating part including a solid electrolyte slurry, a second heating part, a second pressurizing part, a third slurry accommodating part including a second electrode slurry, a third heating part, and a third pressurizing part are sequentially arranged in one line, and the like may be exemplified.

The all-solid-state lithium secondary battery manufactured by the above-described manufacturing method of an all-solid-state lithium secondary battery according to one embodiment of the present invention may exhibit high output characteristics due to reduction of the interface resistance between a positive electrode layer, a solid electrolyte layer, and a negative electrode layer. Further, the above-described manufacturing method of an all-solid-state lithium secondary battery is very simple, and is suitable for mass production of the all-solid-state lithium secondary battery.

Simple modifications and changes of the present invention may be easily performed by those skilled in the art, and these modifications and changes may be included in the scope of the present invention.

1. A manufacturing method of an all-solid-state lithium secondary battery, comprising:
coating a first electrode slurry on a base film proceeding in a roll-to-roll manner, performing a first heat treatment, and performing first pressurization to form a first electrode layer;
coating a solid electrolyte slurry on the first electrode layer, performing a second heat treatment, and performing second pressurization to form a solid electrolyte layer; and
coating a second electrode slurry on the solid electrolyte layer, performing a third heat treatment, and performing third pressurization to form a second electrode layer,
wherein the first electrode is a positive electrode, and the second electrode is a negative electrode, or
the first electrode is a negative electrode, and the second electrode is a positive electrode.

2. The manufacturing method of claim 1, wherein at least one of the first electrode slurry, the solid electrolyte slurry, and the second electrode slurry includes a conductive polymer.

3. The manufacturing method of claim 1, wherein:
the first heat treatment is performed at a temperature of 20° C. to 40° C.;
the second heat treatment is performed at a temperature of 20° C. to 40° C.; or
the third heat treatment is performed at a temperature of 20° C. to 40° C.

4. The manufacturing method of claim 1, further comprising a fourth heat treatment operation after the first heat treatment and before the first pressurization, a fifth heat treatment operation after the second heat treatment and before the second pressurization, or a sixth heat treatment operation after the third heat treatment and before the third pressurization.

5. The manufacturing method of claim 4, wherein:
the fourth heat treatment operation is performed at a temperature of 60° C. to 70° C.;
the fifth heat treatment operation is performed at a temperature of 60° C. to 70° C.; and
the sixth heat treatment operation is performed at a temperature of 60° C. to 70° C.

6. The manufacturing method of claim 1, wherein at least one of the first pressurization, the second pressurization, and the third pressurization is performed by thermocompression.

7. The manufacturing method of claim 6, wherein the thermocompression is performed at a temperature of 60° C. to 70° C. and a pressure of 0.5 MPa to 0.7 MPa.
